(19) United States
(12) Patent Application Publication
(10) Pub. No.: US 2015/0067892 A1
(43) Pub. Date: Mar. 5, 2015

(54) SYSTEM AND METHOD FOR AUTHORIZATION AND AUTHENTICATION, SERVER, TRANSIT TERMINAL

(71) Applicants: Peking University Founder Group Co., Ltd., Beijing (CN); Founder APABI Technology Limited, Beijing (CN)

(72) Inventors: Fengrui ZUO, Beijing (CN); Yingyu Liu, Beijing (CN); Jinbing Yan, Beijing (CN); Peng Li, Beijing (CN); Wei Wang, Beijing (CN)

(73) Assignees: Founder APABI Technology Limited, Beijing (CN); Peking University Founder Group Co., Ltd., Beijing (CN)

(21) Appl. No.: 14/103,995

(22) Filed: Dec. 12, 2013

(30) Foreign Application Priority Data
Aug. 28, 2013 (CN) CN201310382300.6

(51) Int. Cl. H04L 29/06

(52) U.S. Cl. CPC H04L 63/10
USPC 726/29

(57) ABSTRACT

System for authorization and authentication comprises a server and at least one level of transit terminals. The server transmits digital content, server's identifier, and business pattern to the transit terminal. The transit terminal transmits to a lower level transit terminal the digital content, the server's identifier, the business pattern, and identifiers of respective transit terminals through which the digital content passes, and returns the above identifiers to the server. The server performs a match verification on the returned identifiers; if matched, the transit terminal is permitted to parse the business pattern and authorize a client to use the digital content based on privilege in the business pattern.

### CROSS-REFERENCE TO RELATED APPLICATIONS

This application claims priority to Chinese Patent Application No. 201310382300.6, filed on Aug. 28, 2013 and entitled “SYSTEM AND METHOD FOR AUTHORIZATION AND AUTHENTICATION, SERVER, TRANSIT TERMINAL”, which is incorporated herein by reference in its entirety.

### BACKGROUND

1. Field of the Invention

The present invention relates to the field of data authentication techniques, and in particular, to an authorization and authentication system, an authorization and authentication method, a server and a transit terminal.

2. Description of the Related Art

Currently, most agreements between publishers and channel vendors on business patterns of digital productions are offline agreements, i.e., in the form of contracts or the like. Off line business pattern control has a difficulty in tracing, making publishers fall into a passive position and difficult to maintain their benefit.

Digital contents may flow in multiple digital publishing sections. If a channel vendor's business pattern grows out of the control of the publisher, a business pattern against the publisher's will may occur, so that the publisher's interest may be damaged, and the passion of the publisher for digital publishing may be faded.

### SUMMARY OF THE INVENTION

In view of the above problems, an authorization and authentication technique is provided in this invention, which is capable of guaranteeing a publisher's effective control on a digital content in the circulation process of the digital content, prevents an unauthorized channel vendor from accessing the publisher' digital content and prevents a channel vendor from operating the digital content according to a business pattern against the publisher's will, so as to protect the benefit of the publisher.

In view of these, this invention provides a system for authorization and authentication, comprising: a server and at least one level of transit terminal. The server comprises: a data transmission unit, configured to transmit a digital content to the transit terminal, and to transmit an identifier of the server and a business pattern of the digital content to the transit terminal; a match determination unit, configured to determine whether the server's identifier from the transit terminal, and identifiers of respective transit terminals through which the digital content passes from the server to a lower level transit terminal relative to the transit terminal match predetermined identifiers; an instruction sending unit, configured to, in the case of matched as determined by the match determination unit, send a confirmation instruction to the transit terminal to enable the transit terminal to transmit the digital content to a client, and in the case of mismatched as determined by the match determination unit, send a rejection instruction to the transit terminal to prevent the transit terminal from transmitting the digital content to a client. The transit terminal comprises: a data transit unit, configured to transmit the digital content to the lower level transit terminal, and to transmit the server's identifier, the business pattern, and the identifiers of respective transit terminals through which the digital content passes from the server to the lower level transit terminal to the lower level transit terminal, to transmit the server's identifier, the identifiers of respective transit terminals through which the digital content passes from the server to the lower level transit terminal to the server, and to transmit the digital content to the client when receiving the confirmation instruction from the server; a business pattern parsing unit, configured to, when receiving the confirmation instruction from the server, parse the business pattern; an authorization unit, configured to authorize the client to make use of the digital content according to a granted privilege obtained through parsing the business pattern.

In this technical solution, the server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server's identifier, the first level channel vendor's identifier to the server for verification. If the server's identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server's identifier and identifiers of terminal of the channel vendors through which the digital content passes for verification, to ensure that a channel vendor initiating a verification request is permitted to make use of the digital content only if all channel vendors's identifiers are present in the predetermined identifiers. If there is an identifier mismatched with the predetermined identifiers among all the channel vendors's identifiers, it may be determined that digital content has been acquired by an illegal channel vendor, and thereby the channel vendor initiating the verification request may be prevented from making use of the digital content, thus the benefit of the publisher can be effectively protected.

This invention also provides a server comprising: a data transmission unit, configured to transmit a digital content to a transit terminal, and to transmit an identifier of the server and a business pattern of the digital content to the transit terminal; a match determination unit, configured to determine whether the server's identifier from the transit terminal, and identifiers of respective transit terminals through which the digital content passes from the server to a lower level transit terminal relative to the transit terminal match predetermined identifiers; an instruction sending unit, configured to, in the case of matched as determined by the match determination unit, send a confirmation instruction to the transit terminal to enable the transit terminal to transmit the digital content to a client, and in the case of mismatched as determined by the match determination unit, send a rejection instruction to the transit terminal to prevent the transit terminal from transmitting the digital content to the client.

In this technical solution, the server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

This invention also provides a transit terminal comprising: a data transit unit, configured to transmit a digital content from a server to a lower level transit terminal, to transmit to the lower level transit terminal the server's identifier, a business pattern, and identifiers of respective transit terminals through which the digital content passes from the server to the lower level transit terminal, which come from the server, to transmit to the server the server's identifier, and the identifiers of respective transit terminals through which the digital content passes from the server to the lower level transit terminal, and to transmit the digital content to a client when receiving the confirmation instruction from the server; a business pattern parsing unit, configured to,when receiving the confirmation instruction from the server, parse the business pattern; an authorization unit, configured to authorize the client to make use of the digital content according to a granted privilege obtained through parsing the business pattern.

In this technical solution, the server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

This invention also provides a method for authorization and authentication, comprising: step 402 of, when a server transmits a digital content to at least one level of transit terminal, transmitting an identifier of the server and a business pattern of the digital content to the transit terminal; step 404 of, by each of the at least one level of transit terminal, transmitting the digital content to a lower level transit terminal, and transmitting to the lower level transit terminal the identifier of the server, the business pattern, and identifiers of respective transit terminals through which the digital content passes from the server to the lower level transit terminal; step 406 of transmitting to the server by the transit terminal the identifier of the server and the identifiers of respective transit terminals through which the digital content passes from the server to the lower level transit terminal, and determining by the server whether the identifier of the server and the identifiers of respective transit terminals through which the digital content passes from the server to the lower level transit terminal match predetermined identifiers; step 408 of, if matched, sending a confirmation instruction to the transit terminal to enable the transit terminal to transmit the digital content to a client, parse the business pattern, and authorize the client to make use of the digital content according to a granted privilege obtained through parsing the business pattern; if mismatched, sending a rejection instruction to the transit terminal to prevent the transit terminal from transmitting the digital content to the client.

In this technical solution, the server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

This invention also provides a method for authorization and authentication, comprising: step 502 of transmitting by a server a digital content to at least one level of transit terminal, and transmitting an identifier of the server and a business pattern of the digital content to the transit terminal; step 504 of determining by the server whether the identifier of the server and identifiers of respective transit terminals through which the digital content passes from the server to a lower level transit terminal relative to the transit terminal, which come from the transit terminal, match predetermined identifiers; step 506 of, if matched, sending a confirmation instruction to the transit terminal to enable the transit terminal to transmit the digital content to a client; if mismatched, sending a rejection instruction to the transit terminal to prevent the transit terminal from transmitting the digital content to the client.

In this technical solution, the server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

This invention also provides a method for authorization and authentication, comprising: step 602 of, by a transit terminal, transmitting a digital content from a server to a lower level transit terminal, transmitting to the lower level transit terminal the server's identifier, a business pattern, and identifiers of respective transit terminals through which the digital content passes from the server to the lower level transit terminal, which come from the server, transmitting to the server the server's identifier, and the identifiers of respective transit terminals through which the digital content passes from the server to the lower level transit terminal, and transmitting the digital content to a client when receiving a confirmation instruction from the server; step 604 of, by the transit terminal, when receiving the confirmation instruction from the server, parsing the business pattern, and authorizing the client to make use of the digital content according to a granted privilege obtained through parsing the business pattern.

In this technical solution, the server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

By virtue of the above technical solutions, it is possible to effectively ensure that the publisher can effectively control the digital content in the circulation process of the digital content, to prevent an unauthorized channel vendor from accessing the publisher' digital content, and to prevent a channel vendor from operating the digital content according to a business pattern against the publisher's will, and thus the benefit of the publisher can be protected.

### BRIEF DESCRIPTION OF THE DRAWINGS

FIG. 1 shows a schematic block diagram of a system for authorization and authentication according to an embodiment of this invention;

FIG. 2 shows a schematic block diagram of a server according to an embodiment of this invention;

FIG. 3 shows a schematic block diagram of a transit terminal according to an embodiment of this invention;

FIG. 4 shows a schematic flowchart of a method for authorization and authentication according to an embodiment of this invention;

FIG. 5 shows a schematic flowchart of another method for authorization and authentication according to an embodiment of this invention;

FIG. 6 shows a schematic flowchart of still another method for authorization and authentication according to an embodiment of this invention;

FIG. 7 shows a particular schematic block diagram of a system for authorization and authentication according to an embodiment of this invention;

FIG. 8 shows a particular schematic flowchart of a method for authorization and authentication according to an embodiment of this invention;

FIG. 9 shows a schematic interaction diagram of a system for authorization and authentication according to an embodiment of this invention.

### DESCRIPTION OF THE EMBODIMENTS

For a more distinct understanding of the above objects, features and advantageous of this invention, it will be described in a further detail with reference to drawings and particular embodiments below. It should be noticed that, in the case of no conflicts, embodiments and features of embodiments of this invention may be combined with each other.

Many details will be set forth in the following description to achieve a throughout understanding of this invention, however, this invention may be implemented in other ways different from that disclosed herein, and therefore is not limited to the particular embodiments disclosed below.

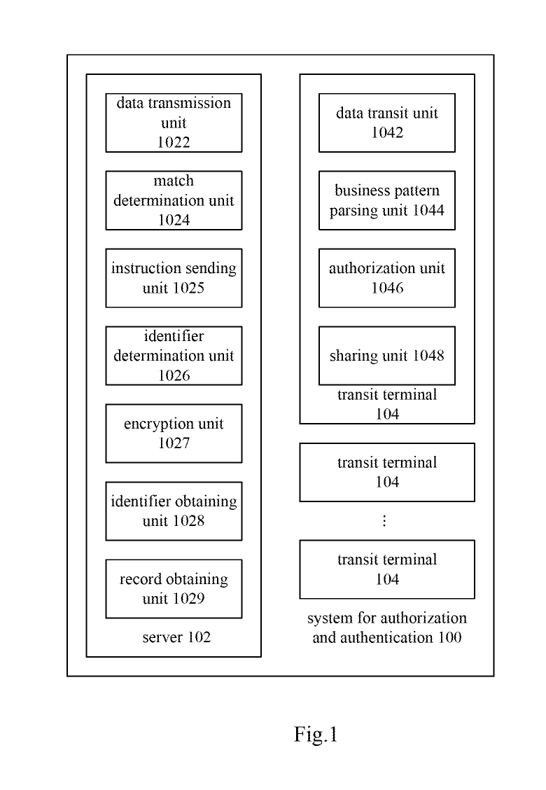

FIG. 1 shows a schematic block diagram of a system for authorization and authentication according to an embodiment of this invention.

As shown in FIG. 1, an authorization and authentication system 100 according to an embodiment of this invention comprises: a server 102 and at least one level of transit terminal 104. The server 102 comprises: a data transmission unit 1022, configured to transmit a digital content to the transit terminal 104, and to transmit an identifier of the server and a business pattern of the digital content to the transit terminal 104; a match determination unit 1024, configured to determine whether the server's identifier from the transit terminal 104, and identifiers of respective transit terminals 104 through which the digital content passes from the server 102 to a lower level transit terminal relative to the transit terminal 104 match predetermined identifiers; an instruction sending unit 1025, configured to, in the case of matched as determined by the match determination unit 1024, send a confirmation instruction to the transit terminal 104 to enable the transit terminal 104 to transmit the digital content to a client, and in the case of mismatched as determined by the match determination unit 1024, send a rejection instruction to the transit terminal 104 to prevent the transit terminal 104 from transmitting the digital content to a client. The transit terminal 104 comprises: a data transit unit 1042, configured to transmit the digital content to the lower level transit terminal, and to transmit the server's identifier, the business pattern, and the identifiers of respective transit terminals 104 through which the digital content passes from the server 102 to the lower level transit terminal to the lower level transit terminal, to transmit the server's identifier, the identifiers of respective transit terminals 104 through which the digital content passes from the server 102 to the lower level transit terminal to the server 102, and to transmit the digital content to the client when receiving the confirmation instruction from the server 102; a business pattern parsing unit 1044, configured to, when receiving the confirmation instruction from the server 102, parse the business pattern; an authorization unit 1046, configured to authorize the client to make use of the digital content according to a granted privilege obtained through parsing the business pattern.

The server 102 may be a server of a publisher, the transit terminal 104 may represent a channel vendor or an integrator. The publisher may distribute a digital content to a channel vendor or integrator via the server 102, wherein the integrator corresponds to a primary channel vendor responsible for forwarding a digital content released by the publisher to multiple channel vendors. Certainly, the publisher may directly distribute the digital content to the channel vendors' terminals via the server 102. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server 102, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server 102 for verification; the server 102 compares the identifier from the channel vendor with predetermined identifiers. The predetermined identifiers may comprise identifiers of channel vendors approved by the publisher in advance and the identifier of the server 102. If the server 102 determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server 102 for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server 102 the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

Preferably, the server 102 further comprises: an identifier determination unit 1026, configured to, in the case of mismatched as determined by the match determination unit 1024, determine identifiers that do not match the predetermined identifiers among the identifier of the server and the identifiers of respective transit terminals 104 through which the digital content passes from the server 102 to the lower level transit terminal, and obtain related information about the mismatched identifiers for displaying.

When the presence of mismatched identifiers is determined by the server 102, there are abnormal identifiers among all the identifiers transmitted to the lower level transit terminal, i.e., there are channel vendors who have obtained the digital content without permission of the publisher. Then, related information regarding the mismatched identifiers among all the identifiers transmitted to the lower level transit terminal is determined. The related information may be the name of a transit terminal 104 corresponding to the identifier (equivalent to the name of a channel vendor), a time at which the identifier is added to the digital content, an upper level transit terminal and a lower level transit terminal relative to a transit terminal corresponding to the identifier, and so on, and thereby the publisher may catch sight of the information of those illegal transit terminals on the server 102 clearly, and may carry out corresponding processes accordingly.

Preferably, the data transit unit 1042 is further configured to, when the digital content is transmitted to the client, transmit to the client the identifier of the server and identifiers of respective transit terminals 104 through which the digital content passes from the server 102 to the client. The server 102 further comprises: an encryption unit 1027, configured to encrypt the digital content according to a predetermined algorithm; an identifier obtaining unit 1028, configured to, after receiving a decryption request from the client, obtain from the client the identifier of the server and the identifiers of respective transit terminals 104 through which the digital content passes from the server to the client. The match determination unit 1024 is further configured to determine whether the identifier of the server and the identifiers of respective transit terminals 104 through which the digital content passes from the server 102 to the client match the predetermined identifiers. The data transmission unit 1022 is further configured to, if matched as determined by the match determination unit, send to the client a key corresponding to the predetermined algorithm to enable the client to decrypt the digital content with the key.

Before transmitting the digital content to the transit terminal, according to a setting from a user (such as, the publisher), the server 102 may encrypt the digital content according to a predetermined algorithm (such as, encrypt it according to an asymmetric algorithm). When a client obtains the digital content through a transaction with the transit terminal 104, it may send a decryption request to the server 102 to obtain a key used for the digital content. When the server 102 receives the request from the client, it may obtain all the identifiers transmitted to the client from the transit terminal 104 making the transaction with the client, and verify whether these identifiers match the predetermined identifiers; if matched, it represents that all transit terminals 104 through which the digital content passes during the transmission to the client are legal transit terminals; if mismatched, it represents that there are illegal transit terminals that are not authorized by the server 102 among the transit terminals 104 through which the digital content passes during the transmission to the client, and thereby the decryption request of the client may be rejected and a prompt message may be sent to the client. Therefore, a transaction between an illegal transit terminal and the client can be avoided to effectively protect the benefit of the publisher.

Preferably, the system further comprises: a record obtaining unit 1029, configured to obtain from the transit terminal 104 a record of the transaction between the transit terminal 104 and the client. The match determination unit 1024 is further configured to determine whether a privilege recorded in the transaction record matches a privilege specified in a business pattern corresponding to the transit terminal 104, and if mismatched, send a prompt message.

After a transaction between a client and a transit terminal 104 is completed, the server may obtain from the client a transaction record of its transaction with the transit terminal 104. The transaction record may comprise a transaction time, a transit terminal on which the transaction is carried out, and a granted privilege, and the like. Because the server 102 may grant different privileges to different transit terminals 104, through determining whether a privilege recorded in the transaction record matches a privilege specified in the business pattern sent from the server 102 to the transit terminal 104, it may be determined whether the transit terminal 104 abuses a transaction privilege that is not granted by the server 102 to conduct the transaction with the client, so that it may be ensured that the publisher (equivalent to the server 102) may effectively monitor the transaction of the digital content, and thus the benefit of the publisher may be guaranteed.

Note that the record obtaining unit 1029 and the identifier obtaining unit 1028 may practically be one obtaining module, and the obtaining operation of the record obtaining unit 1029 may be an active operation (i.e., the server 102 obtains the record of the transaction between the client and the transit terminal 104 from the client), or may be a passive operation (i.e., the client sends the record of the transaction between the client and the transit terminal 104 to the server 102).

Preferably, the transit terminal 104 further comprises: a sharing unit 1048, configured to, after the client obtaining the digital content from the transit terminal 104 has paid for the digital content, share the payment of the client with the server 102 according to a sharing rule obtained through parsing the business pattern.

After a transaction between a client and a transit terminal 104 is completed, the transit terminal 104 may automatically share with the server 102 a payment of the client, according to a sharing rule specified in the business pattern, to thereby ensure that the publisher (equivalent to the server 102) may gain a proper percentage of the payment that is specified by publisher himself timely, effectively protecting the benefit of the publisher.

Note that the sharing unit 1048 may also be provided in the server 102 as required by users, to enable the server 102 to realize the operation of sharing the payment of the client.

Preferably, the data transit unit 1042 is further configured to transmit the business pattern to the server 102, and the match determination unit 1024 is further configured to determine whether the business pattern matches a predetermined business pattern.

Respective levels of the transit terminals 104 may further return a business pattern received from an upper level transit terminal or the server 102 to the server. The server may then compare the business pattern returned from the transit terminal 104 with a predetermined business pattern; if matched, it represents that the business pattern has not been falsified by the transit terminal 104, and the transit terminal 104 is permitted to parse the business pattern and conduct the transaction with the client; if mismatched, it represents that the business pattern has been falsified by the transit terminal 104, and the transit terminal 104 is prevented from conducting the transaction with the client. Therefore it may be ensured that the publisher (equivalent to the server 102) may effectively monitor the transaction of the digital content, to prevent a channel vendor (equivalent to the transit terminal 104) from abusing a business pattern that is not authorized by the server 102 in the transaction with the client, and thereby effectively protect the benefit of the publisher.

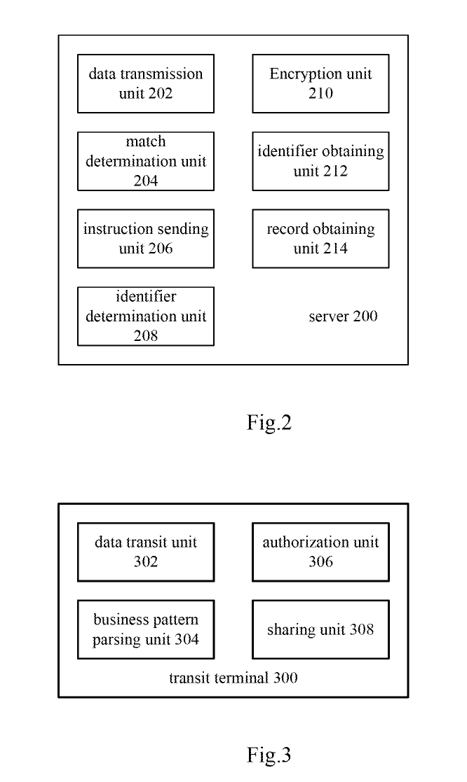

FIG. 2 shows a schematic block diagram of a server according to an embodiment of this invention.

As shown in FIG. 2, a server 200 according to the embodiment of this invention comprises: a data transmission unit 202, configured to transmit a digital content to a transit terminal, and to transmit an identifier of the server and a business pattern of the digital content to the transit terminal; a match determination unit 204, configured to determine whether the server's identifier from the transit terminal, and identifiers of respective transit terminals through which the digital content passes from the server 200 to a lower level transit terminal relative to the transit terminal match predetermined identifiers; an instruction sending unit 206, configured to, in the case of matched as determined by the match determination unit 204, send a confirmation instruction to the transit terminal to enable the transit terminal to transmit the digital content to a client, and in the case of mismatched as determined by the match determination unit 204, send a rejection instruction to the transit terminal to prevent the transit terminal from transmitting the digital content to the client.

The server 200 may be a server of a publisher, the transit terminal may represent a channel vendor or an integrator. The publisher may distribute a digital content to a channel vendor or integrator via the server 200, wherein the integrator corresponds to a primary channel vendor responsible for forwarding a digital content released by the publisher to multiple channel vendors. Certainly, the publisher may directly distribute the digital content to the channel vendors' terminals via the server 200. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server 200, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server 200 for verification; the server 200 compares the identifier from the channel vendor with predetermined identifiers. The predetermined identifiers may comprise identifiers of channel vendors approved by the publisher in advance and the identifier of the server 200. If the server 200 determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server 200 for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server 200 the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

Preferably, the server further comprises: an identifier determination unit 208, configured to, in the case of mismatched as determined by the match determination unit 204, determine identifiers that do not match the predetermined identifiers among the identifier of the server and the identifiers of respective transit terminals through which the digital content passes from the server 200 to the lower level transit terminal, and obtain related information about the mismatched identifiers for displaying.

When the presence of mismatched identifiers is determined by the server 200, there are abnormal identifiers among all the identifiers transmitted to the lower level transit terminal, i.e., there are channel vendors who have obtained the digital content without permission of the publisher. Then, related information regarding the mismatched identifiers among all the identifiers transmitted to the lower level transit terminal is determined. The related information may be the name of a transit terminal corresponding to the identifier (equivalent to the name of a channel vendor), a time at which the identifier is added to the digital content, an upper level transit terminal and a lower level transit terminal relative to a transit terminal corresponding to the identifier, and so on, and thereby the publisher may catch sight of the information of those illegal transit terminals on the server 200 clearly, and may carry out corresponding processes accordingly.

Preferably, the server further comprises: an encryption unit 210, configured to encrypt the digital content according to a predetermined algorithm; an identifier obtaining unit 212, configured to, after receiving a decryption request from the client, obtain from the client the identifier of the server and the identifiers of respective transit terminals through which the digital content passes from the server 200 to the client. The match determination unit 204 is further configured to determine whether the identifier of the server and the identifiers of respective transit terminals through which the digital content passes from the server 200 to the client match the predetermined identifiers. The data transmission unit 202 is further configured to, if matched as determined by the match determination unit 204, send to the client a key corresponding to the predetermined algorithm to enable the client to decrypt the digital content with the key.

Before transmitting the digital content to the transit terminal, according to a setting from a user (such as, the publisher), the server 200 may encrypt the digital content according to a predetermined algorithm (such as, encrypt it according to an asymmetric algorithm). When a client obtains the digital content through a transaction with the transit terminal, it may send a decryption request to the server 200 to obtain a key used for the digital content. When the server 200 receives the request from the client, it may obtain all the identifiers transmitted to the client from the transit terminal making the transaction with the client, and verify whether these identifiers match the predetermined identifiers; if matched, it represents that all transit terminals 104 through which the digital content passes during the transmission to the client are legal transit terminals; if mismatched, it represents that there are illegal transit terminals that are not authorized by the server 200 among the transit terminals through which the digital content passes during the transmission to the client, and thereby the decryption request of the client may be rejected and a prompt message may be sent to the client. Therefore, a transaction between an illegal transit terminal and the client can be avoided to effectively protect the benefit of the publisher.

Preferably, the server further comprises: a record obtaining unit 214, configured to obtain from the transit terminal a record of the transaction between the transit terminal and the client. The match determination unit 204 is further configured to determine whether a privilege recorded in the transaction record matches a privilege specified in a business pattern corresponding to the transit terminal, and if mismatched, send a prompt message.

After a transaction between a client and a transit terminal is completed, the server may obtain from the client a transaction record of its transaction with the transit terminal. The transaction record may comprise a transaction time, a transit terminal on which the transaction is carried out, and a granted privilege, and the like. Because the server 200 may grant different privileges to different transit terminals, through determining whether a privilege recorded in the transaction record matches a privilege specified in the business pattern sent from the server 200 to the transit terminal, it may be determined whether the transit terminal abuses a transaction privilege that is not granted by the server 200 to conduct the transaction with the client, so that it may be ensured that the publisher (equivalent to the server 200) may effectively monitor the transaction of the digital content, and thus the benefit of the publisher may be guaranteed.

Note that the record obtaining unit 214 and the identifier obtaining unit 212 may practically be one obtaining module, and the obtaining operation of the record obtaining unit 214 may be an active operation (i.e., the server 200 obtains the record of the transaction between the client and the transit terminal from the client), or may be a passive operation (i.e., the client sends the record of the transaction between the client and the transit terminal to the server 200).

FIG. 3 shows a schematic block diagram of a transit terminal according to an embodiment of this invention.

As shown in FIG. 3, a transit terminal 300 according to the embodiment of this invention comprises: a data transit unit 302, configured to transmit a digital content from a server to a lower level transit terminal, to transmit to the lower level transit terminal the server's identifier, a business pattern, and identifiers of respective transit terminals 300 through which the digital content passes from the server to the lower level transit terminal, which come from the server, to transmit to the server the server's identifier, and the identifiers of respective transit terminals 300 through which the digital content passes from the server to the lower level transit terminal, and to transmit the digital content to a client when receiving the confirmation instruction from the server; a business pattern parsing unit 304, configured to, when receiving the confirmation instruction from the server, parse the business pattern; an authorization unit 306, configured to authorize the client to make use of the digital content according to a granted privilege obtained through parsing the business pattern.

The server may be a server of a publisher, the transit terminal 300 may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

Preferably, the transit terminal further comprises: a sharing unit 308, configured to, after the client obtaining the digital content from the transit terminal 300 has paid for the digital content, share the payment of the client with the server according to a sharing rule obtained through parsing the business pattern.

After a transaction between a client and a transit terminal 300 is completed, the transit terminal 300 may automatically share with the server 102 a payment of the client, according to a sharing rule specified in the business pattern, to thereby ensure that the publisher (equivalent to the server 102) may gain a proper percentage of the payment that is specified by publisher himself timely, effectively protecting the benefit of the publisher.

Note that the sharing unit 308 may also be provided in the server as required by users, to enable the server to realize the operation of sharing the payment of the client.

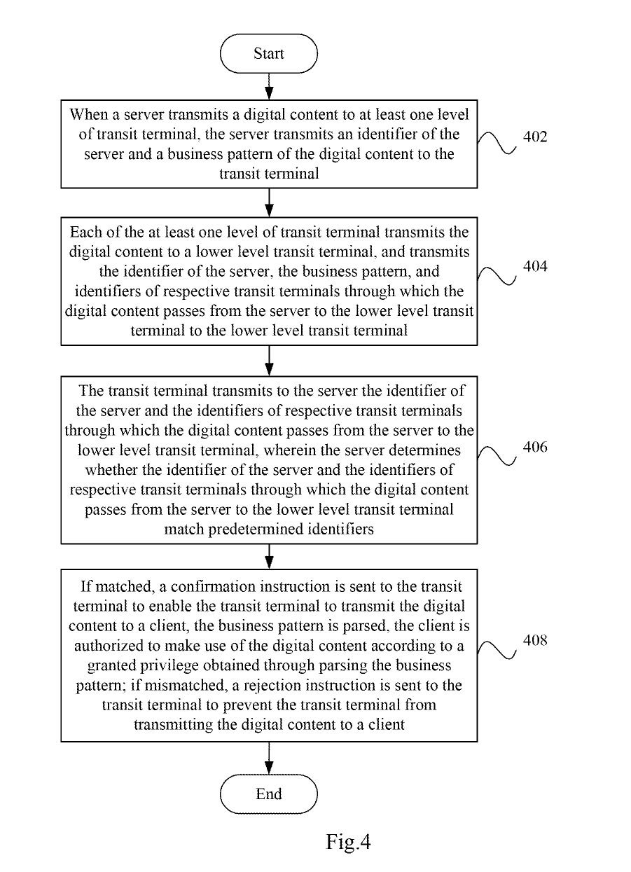

FIG. 4 shows a schematic flowchart of an authorization and authentication method according to an embodiment of this invention.

As shown in FIG. 4, an authorization and authentication method according to the embodiment of this invention comprises: step 402 of, when a server transmits a digital content to at least one level of transit terminal, transmitting an identifier of the server and a business pattern of the digital content to the transit terminal; step 404 of, by each of the at least one level of transit terminal, transmitting the digital content to a lower level transit terminal, and transmitting to the lower level transit terminal the identifier of the server, the business pattern, and identifiers of respective transit terminals through which the digital content passes from the server to the lower level transit terminal; step 406 of transmitting to the server by the transit terminal the identifier of the server and the identifiers of respective transit terminals through which the digital content passes from the server to the lower level transit terminal, and determining by the server whether the identifier of the server and the identifiers of respective transit terminals through which the digital content passes from the server to the lower level transit terminal match predetermined identifiers; step 408 of, if matched, sending a confirmation instruction to the transit terminal to enable the transit terminal to transmit the digital content to a client, parse the business pattern, and authorize the client to make use of the digital content according to a granted privilege obtained through parsing the business pattern; if mismatched, sending a rejection instruction to the transit terminal to prevent the transit terminal from transmitting the digital content to the client.

The server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server's identifier, the first level channel vendor's identifier to the server for verification. If the server's identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server's identifier and identifiers of terminal of the channel vendors through which the digital content passes for verification, to ensure that a channel vendor initiating a verification request is permitted to make use of the digital content only if all channel vendors's identifiers are present in the predetermined identifiers. If there is an identifier mismatched with the predetermined identifiers among all the channel vendors's identifiers, it may be determined that digital content has been acquired by an illegal channel vendor, and thereby the channel vendor initiating the verification request may be prevented from making use of the digital content, thus the benefit of the publisher can be effectively protected.

Preferably, the step 408 further comprises: in the case of mismatched as determined by the server, determining identifiers that do not match the predetermined identifiers among the identifier of the server and the identifiers of respective transit terminals through which the digital content passes from the server to the lower level transit terminal, and obtaining related information about the mismatched identifiers for displaying.

When the presence of mismatched identifiers is determined by the server, there are abnormal identifiers among all the identifiers transmitted to the lower level transit terminal, i.e., there are channel vendors who have obtained the digital content without permission of the publisher. Then, related information regarding the mismatched identifiers among all the identifiers transmitted to the lower level transit terminal is determined. The related information may be the name of a transit terminal corresponding to the identifier (equivalent to the name of a channel vendor), a time at which the identifier is added to the digital content, an upper level transit terminal and a lower level transit terminal relative to a transit terminal corresponding to the identifier, and so on, and thereby the publisher may catch sight of the information of those illegal transit terminals on the server clearly, and may carry out corresponding processes accordingly.

Preferably, before step 402, the method further comprises: encrypting the digital content according to a predetermined algorithm by the server. The step 408 further comprises: when the transit terminal transmits the digital content to the client, transmitting by the transit terminal to the client the identifier of the server and the identifiers of respective transit terminals through which the digital content passes from the server to the client; wherein after receiving a decryption request from the client, the server obtains from the client the identifier of the server and the identifiers of respective transit terminals through which the digital content passes from the server to the client, determines whether the identifier of the server and the identifiers of respective transit terminals through which the digital content passes from the server to the client match the predetermined identifiers, and if matched, sends a key corresponding to the predetermined algorithm to the client to enable the client to decrypt the digital content with the key.

Before transmitting the digital content to the transit terminal, according to a setting from a user (such as, the publisher), the server may encrypt the digital content according to a predetermined algorithm (such as, encrypt it according to an asymmetric algorithm). When a client obtains the digital content through a transaction with the transit terminal, it may send a decryption request to the server to obtain a key used for the digital content. When the server receives the request from the client, it may obtain all the identifiers transmitted to the client from the transit terminal making the transaction with the client, and verify whether these identifiers match the predetermined identifiers; if matched, it represents that all transit terminals through which the digital content passes during the transmission to the client are legal transit terminals; if mismatched, it represents that there are illegal transit terminals that are not authorized by the server among the transit terminals through which the digital content passes during the transmission to the client, and thereby the decryption request of the client may be rejected and a prompt message may be sent to the client. Therefore, a transaction between an illegal transit terminal and the client can be avoided to effectively protect the benefit of the publisher.

Preferably, the method further comprises: obtaining by the server from the transit terminal a record of the transaction between the transit terminal and the client, wherein the match determination unit further determines whether a privilege recorded in the transaction record matches a privilege specified in a business pattern corresponding to the transit terminal, and if mismatched, sends a prompt message.

After a transaction between a client and a transit terminal is completed, the server may obtain from the client a transaction record of its transaction with the transit terminal. The transaction record may comprise a transaction time, a transit terminal on which the transaction is carried out, and a granted privilege, and the like. Because the server may grant different privileges to different transit terminals, through determining whether a privilege recorded in the transaction record matches a privilege specified in the business pattern sent from the server to the transit terminal, it may be determined whether the transit terminal abuses a transaction privilege that is not granted by the server to conduct the transaction with the client, so that it may be ensured that the publisher (equivalent to the server) may effectively monitor the transaction of the digital content, and thus the benefit of the publisher may be guaranteed.

Preferably, the method further comprises: after the client obtaining the digital content from the transit terminal has paid for the digital content, by the transit terminal, sharing the payment of the client with the server, according to a sharing rule obtained through parsing the business pattern.

After a transaction between a client and a transit terminal is completed, the transit terminal may automatically share with the server a payment of the client, according to a sharing rule specified in the business pattern, to thereby ensure that the publisher (equivalent to the server) may gain a proper percentage of the payment that is specified by publisher himself timely, effectively protecting the benefit of the publisher.

Preferably, the step 406 further comprises: transmitting the business pattern from the transit terminal to the server, and determining whether the business pattern matches a predetermined business pattern by the server.

Respective levels of the transit terminals may further return a business pattern received from an upper level transit terminal or the server to the server. The server may then compare the business pattern returned from the transit terminal with a predetermined business pattern; if matched, it represents that the business pattern has not been falsified by the transit terminal, and the transit terminal is permitted to parse the business pattern and conduct the transaction with the client; if mismatched, it represents that the business pattern has been falsified by the transit terminal, and the transit terminal is prevented from conducting the transaction with the client. Therefore it may be ensured that the publisher (equivalent to the server) may effectively monitor the transaction of the digital content, to prevent a channel vendor (equivalent to the transit terminal) from abusing a business pattern that is not authorized by the server in the transaction with the client, and thereby effectively protect the benefit of the publisher.

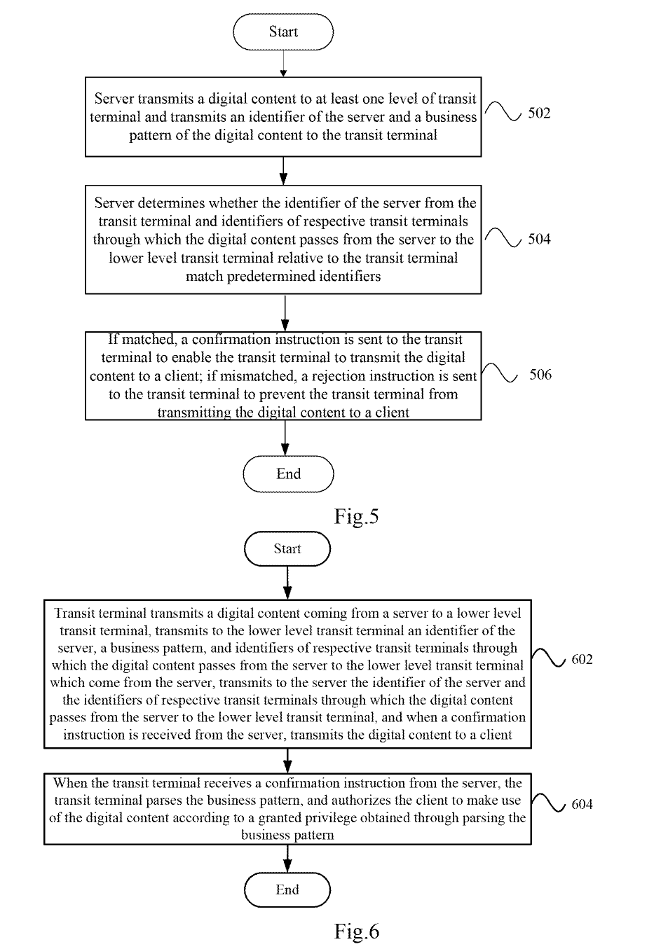

FIG. 5 shows a schematic flowchart of another authorization and authentication method according to an embodiment of this invention.

As shown in FIG. 5, another authorization and authentication method according to the embodiment of this invention comprises: step 502 of transmitting by a server a digital content to at least one level of transit terminal, and transmitting an identifier of the server and a business pattern of the digital content to the transit terminal; step 504 of determining by the server whether the identifier of the server and identifiers of respective transit terminals through which the digital content passes from the server to a lower level transit terminal relative to the transit terminal, which come from the transit terminal, match predetermined identifiers; step 506 of, if matched, sending a confirmation instruction to the transit terminal to enable the transit terminal to transmit the digital content to a client; if mismatched, sending a rejection instruction to the transit terminal to prevent the transit terminal from transmitting the digital content to the client.

The server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

Preferably, the method further comprises: in the case of mismatched as determined by the server, determining identifiers that do not match the predetermined identifiers among the identifier of the server and the identifiers of respective transit terminals through which the digital content passes from the server to the lower level transit terminal, and obtaining related information about the mismatched identifiers for displaying.

When the presence of mismatched identifiers is determined by the server, there are abnormal identifiers among all the identifiers transmitted to the lower level transit terminal, i.e., there are channel vendors who have obtained the digital content without permission of the publisher. Then, related information regarding the mismatched identifiers among all the identifiers transmitted to the lower level transit terminal is determined. The related information may be the name of a transit terminal corresponding to the identifier (equivalent to the name of a channel vendor), a time at which the identifier is added to the digital content, an upper level transit terminal and a lower level transit terminal relative to a transit terminal corresponding to the identifier, and so on, and thereby the publisher may catch sight of the information of those illegal transit terminals on the server clearly, and may carry out corresponding processes accordingly.

Preferably, before step 502, the method further comprises: encrypting the digital content according to a predetermined algorithm by the server; and the step 506 further comprises: by the server, obtaining from the client the identifier of the server and the identifiers of respective transit terminals through which the digital content passes from the server to the client, after a decryption request from the client is received, and determining whether the identifier of the server and the identifiers of respective transit terminals through which the digital content passes from the server to the client match the predetermined identifiers, and if matched, sending a key corresponding to the predetermined algorithm to the client to enable the client to decrypt the digital content with the key.

Before transmitting the digital content to the transit terminal, according to a setting from a user (such as, the publisher), the server may encrypt the digital content according to a predetermined algorithm (such as, encrypt it according to an asymmetric algorithm). When a client obtains the digital content through a transaction with the transit terminal, it may send a decryption request to the server to obtain a key used for the digital content. When the server receives the request from the client, it may obtain all the identifiers transmitted to the client from the transit terminal making the transaction with the client, and verify whether these identifiers match the predetermined identifiers; if matched, it represents that all transit terminals through which the digital content passes during the transmission to the client are legal transit terminals; if mismatched, it represents that there are illegal transit terminals that are not authorized by the server among the transit terminals through which the digital content passes during the transmission to the client, and thereby the decryption request of the client may be rejected and a prompt message may be sent to the client. Therefore, a transaction between an illegal transit terminal and the client can be avoided to effectively protect the benefit of the publisher.

Preferably, the method further comprises: obtaining by the server from the transit terminal a record of the transaction between the transit terminal and the client, wherein the match determination unit further determines whether a privilege recorded in the transaction record matches a privilege specified in a business pattern corresponding to the transit terminal, and if mismatched, sends a prompt message.

After a transaction between a client and a transit terminal is completed, the server may obtain from the client a transaction record of its transaction with the transit terminal. The transaction record may comprise a transaction time, a transit terminal on which the transaction is carried out, and a granted privilege, and the like. Because the server may grant different privileges to different transit terminals, through determining whether a privilege recorded in the transaction record matches a privilege specified in the business pattern sent from the server to the transit terminal, it may be determined whether the transit terminal abuses a transaction privilege that is not granted by the server to conduct the transaction with the client, so that it may be ensured that the publisher (equivalent to the server) may effectively monitor the transaction of the digital content, and thus the benefit of the publisher may be guaranteed.

FIG. 6 shows a schematic flowchart of still another authorization and authentication method according to an embodiment of this invention.

As shown in FIG. 6, the still another authorization and authentication method according to the embodiment of this invention comprises: step 602 of, by a transit terminal, transmitting a digital content from a server to a lower level transit terminal, transmitting to the lower level transit terminal the server's identifier, a business pattern, and identifiers of respective transit terminals through which the digital content passes from the server to the lower level transit terminal, which come from the server, transmitting to the server the server's identifier, and the identifiers of respective transit terminals through which the digital content passes from the server to the lower level transit terminal, and transmitting the digital content to a client when receiving a confirmation instruction from the server; step 604 of, by the transit terminal, when receiving the confirmation instruction from the server, parsing the business pattern, and authorizing the client to make use of the digital content according to a granted privilege obtained through parsing the business pattern.

The server may be a server of a publisher, the transit terminal may represent a channel vendor or an integrator. The publisher may distribute a digital content to a channel vendor or integrator via the server, wherein the integrator corresponds to a primary channel vendor responsible for forwarding a digital content released by the publisher to multiple channel vendors. Certainly, the publisher may directly distribute the digital content to the channel vendors' terminals via the server. The channel vendors may be divided into several levels of channel vendors, each level may, on the one hand, authorize the digital content to a client through rent, sale or the like, on the other hand, may forward the digital content to a lower level channel vendor. Also, each level may comprise multiple channel vendors, and transit operations are carried out on terminals of those channel vendors and integrators in the process of distributing the digital content from the publisher's server to a client.

The publisher may specify a business pattern corresponding to the digital content via the server, for example, a business pattern of allowing for rent but not for sale, a business pattern of allowing for rent and sale. Before the publisher distributes a digital content to a channel vendor through the server, the digital content may be identified at first, particularly, it may be identified with the identifier of the server itself. When the digital content is transmitted to the channel vendor, a business pattern corresponding to the digital content is also transmitted. When a first level channel vendor receives the digital content, the business pattern corresponding to the digital content must be parsed to obtain a privilege corresponding to the digital content in the business pattern; at this point, the first level channel vendor's terminal returns the server identifier to the server for verification; the server compares the identifier from the channel vendor with predetermined identifiers. The predetermined identifiers may comprise identifiers of channel vendors approved by the publisher in advance and the identifier of the server. If the server determines that the identifier from the channel vendor coincides with at least one of the predetermined identifiers, i.e., match is determined, an instruction is sent to the first level channel vendor to allow the first level channel vendor to parse the business pattern. For example, if the obtained privilege is a license for sale and rent, the first level channel vendor may not only rent the digital content to a client, but also sell it to the client. Through returning the identifier to the publisher's server for verification, it may ensure that only a channel vendor specified by the publisher is entitled to the digital content, and due to setting a business pattern, the channel vendor has to make transactions with clients based on the business pattern specified by the publisher, so that transactions between the channel vendor and the clients in improper business pattern can be avoided.

Further, the first level channel vendor may distribute the digital content to a second level channel vendor, and send to the second level channel vendor's terminal the server's identifier, the first level channel vendor's identifier and the business pattern of the digital content. The second level channel vendor needs to parse the business pattern corresponding to the digital content to obtain a privilege corresponding to the digital content in the business pattern, and returns the server' identifier, the first level channel vendor's identifier to the server for verification. If the server' identifier and the first level channel vendor's identifier are both present in the predetermined identifiers, i.e., match may be determined, the second level channel vendor is permitted to make use of the digital content, and so on. In order to acquire the permission of make use of the digital content, respective levels of channel vendors must send to the server the server' identifier and identifiers of terminal of the channel vendors through which the digital content passes for verification, to ensure that a channel vendor initiating a verification request is permitted to make use of the digital content only if all channel vendors' identifiers are present in the predetermined identifiers. If there is an identifier mismatched with the predetermined identifiers among all the channel vendors' identifiers, it may be determined that digital content has been acquired by an illegal channel vendor, and thereby the channel vendor initiating the verification request may be prevented from making use of the digital content, thus the benefit of the publisher can be effectively protected.

Preferably, the method further comprises: after the client obtaining the digital content from the transit terminal has paid for the digital content, by the transit terminal, sharing the payment of the client with the server, according to a sharing rule obtained through parsing the business pattern.

After a transaction between a client and a transit terminal is completed, the transit terminal may automatically share with the server a payment of the client, according to a sharing rule specified in the business pattern, to thereby ensure that the publisher (equivalent to the server) may gain a proper percentage of the payment that is specified by publisher himself timely, effectively protecting the benefit of the publisher.

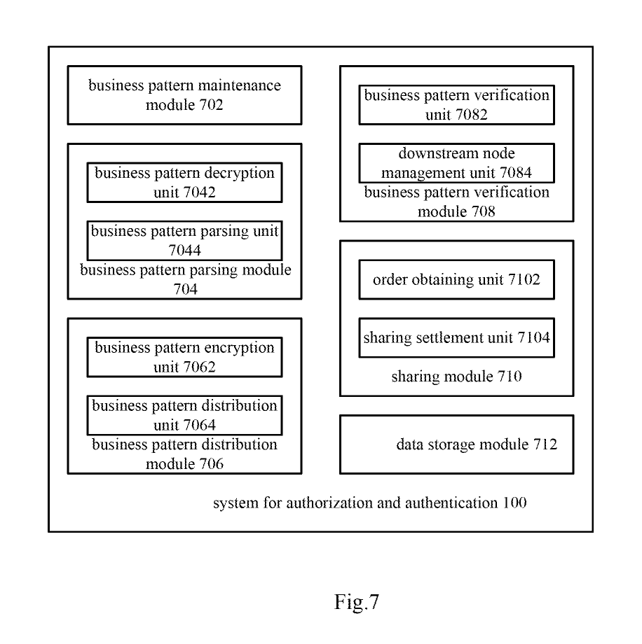

FIG. 7 shows a particular schematic block diagram of an authorization and authentication system according to an embodiment of this invention.

As shown in FIG. 7, an authorization and authentication system 100 according to the embodiment of this invention may particularly comprise: a business pattern maintenance module 702, a business pattern parsing module 704, a business pattern distribution module 706, a business pattern verification module 708, a sharing module 710, and a data storage module 712.

The business pattern maintenance module 702 mainly performs maintenance operations, such as defining, querying and modifying operations, on a business pattern of a digital content, such as a single sale pattern, a rent pattern, a service pattern, and the like, each pattern having a corresponding sharing agreement, i.e., each pattern having a different sharing algorithm.

The business pattern parsing module 704 (corresponding to the business pattern parsing unit 1044 shown in FIG. 1) mainly comprises a business pattern decryption unit 7042 and a business pattern parsing unit 7044, and mainly decrypts and parses the business pattern of the digital content. The business pattern decryption unit 7042 requests a business pattern verification unit 7082 to verify the validity of a privilege. The business pattern parsing module 704 may parse the business pattern only if the privilege is valid.

The business pattern distribution module 706 mainly comprises a business pattern encryption unit 7062 (provided in the server) and a business pattern distribution unit 7064 (corresponding to the data transmission unit 1022 shown in FIG. 1 if provided in the server; or corresponding to the data transit unit 1042 shown in FIG. 1 if provided in the transit terminal), for transmitting the business pattern of the digital content. The business pattern encryption unit 7062 is responsible for encrypting the business pattern of the digital content with, for example, an asymmetric encrypting algorithm; the business pattern distribution unit 7064 requests information (not including its identifier) of a visible downstream node from the business pattern verification module 708, and after the publisher selects a node to which the business pattern will distributed, signs the business pattern of the digital content with information such as its identifier and then distributes it to the downstream node.

The business pattern verification module 708 (corresponding to the match determination unit 1024 shown in FIG. 1) mainly comprises a downstream node management unit 7084, a business pattern verification unit 7082. The downstream node management unit 7084 is responsible for managing information such as identifiers and names of respective downstream nodes in digital publishing business; and the business pattern verification unit 7082 is responsible for verifying the validity of the business pattern when the digital content is used by respective business nodes.

The sharing module 710 (corresponding to the sharing unit 1048 shown in FIG. 1, which may be provided in the server or the transit terminal as required by users) mainly comprises: an order obtaining unit 7102, a sharing settlement unit 7104, mainly for performing a sharing calculation according to the business pattern of the digital content and an order returned from a channel vendor or a client, and sharing a payment for the order between the publisher and the channel vendor according to a sharing rule specified in the business pattern, making sure that the publisher may gain corresponding interests.

The data storage module 712 is configured to store related data information in the authorization and authentication system 100.

The data storage module 712 mainly stores four types of data items: business pattern information items, digital content information items, business pattern key information items and channel vendor order lists. The business pattern information items are used to store and manage business patterns of digital contents; the digital content information items are used to store and manage meta data related to digital contents and digital content encryption information, such as names of digital contents, unique identifiers of digital contents, full paths of encrypted digital content objects, digital content object encryption key information; the business pattern distribution information items are used to store and manage information of respective business nodes to which the business patterns of digital contents are distributed, distribution times, etc; the channel vendor order lists are mainly used to store sale orders of channel vendors for reconciliation and sharing.

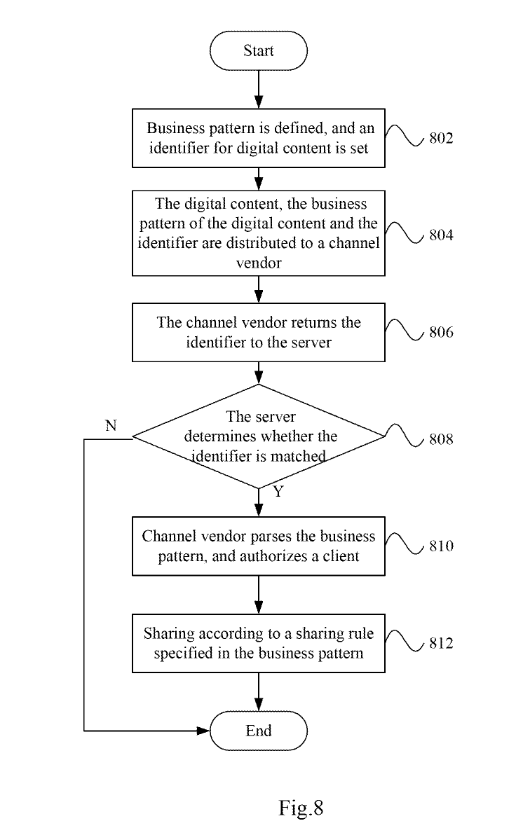

FIG. 8 shows a particular schematic flowchart of an authorization and authentication method according to an embodiment of this invention.

As shown in FIG. 8, an authorization and authentication method according to the embodiment of this invention particularly comprises the following steps.

At step 802, a publisher sets a business pattern for a digital content via a server and sets an identifier for the digital content;

At step 804, the publisher distributes the digital content, the business pattern of the digital content and an identifier set for the digital content (such as, a server identifier) to respective levels of channel vendors (corresponding to transit terminals) through the server;

At step 806, after receiving the digital content, a channel vendor returns the identifier information for the digital content to the server for verification;

At step 808, the server determines whether the identifier returned from the channel vendor matches a predetermined identifier in the server; if mismatched, the channel vendor is prevented from parsing the business pattern;

At step 810, if matched, the channel vendor is permitted to parse the business pattern, and the channel vendor authorizes a client to make use of the digital content according to a privilege obtained through parsing the business pattern;

At step 812, the channel vendor shares a payment of the client with the publisher according to a sharing rule specified in the business pattern.

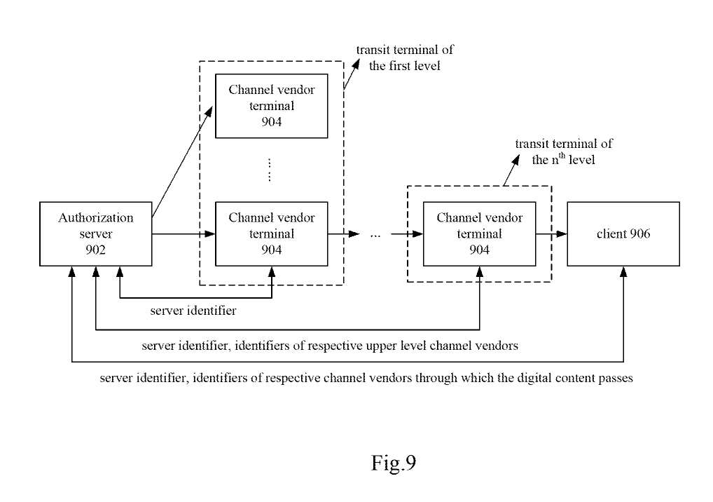

FIG. 9 shows a schematic interaction diagram of an authorization and authentication system according to an embodiment of this invention.

As shown in FIG. 9, an authorization server 902 (such as a publisher's server) transmits a digital content to at least one level of transit terminal, wherein each level of transit terminal comprise at least one channel vendor terminal 904, and each channel vendor terminal 904 may, on the one hand, authorize a client 906 to make use of the digital content, on the other hand, may forward the digital content to a lower level channel vendor' terminal 904.

When a channel vendor terminal 904 at the first level of transit terminals receives the digital content, because only the identifier of the server is attached to the digital content at this point, the identifier of the server is returned to the authorization server 902 for match verification. As to a channel vendor terminal 904 at the n^{th} level of transit terminals, when a digital content that is forwarded from a channel vendor at the (n−1)^{th} level is received, the digital content has the identifier of the server and identifiers of respective channel vendor terminals through which the digital content passes before reaching this channel vendor terminal 904 attached thereto, and thus this channel vendor terminal 904 returns all the identifiers attached to the digital content to the authorization server 902 for match verification. If the verification on the authorization server 902 is passed, the channel vendor terminal 904 is permitted to parse the business pattern of the digital content, and then authorize the client 906 according to a privilege obtained through parsing the business pattern.

When the client 906 obtains the digital content through a transaction, it may return the attached identifier of the server and identifiers of respective channel vendor terminals 904 through which the digital content passes before reaching the client 906 to the authorization server 902 for match verification. If the verification is passed, the authorization server 902 distributes a key to the client 906, enabling the client 906 to decrypt the digital content.

Technical solutions of this invention have been particularly described above with reference to drawings. In view of the fact in related arts that most agreements between publishers and channel vendors on business patterns of digital contents are offline agreements, it is difficult for publishers to have effective control on digital contents in distribution, making publishers in a passive situation, in which it is difficult to maintain their benefit. With the technical solutions of this invention, it may be ensured that a publisher may have effective control on a digital content in distribution, to prevent illegal channel vendors from obtaining the publisher's digital content, and prevent a channel vendor from operating the digital content in a business pattern against the will of the publisher, so that the publisher's benefit can be guaranteed.

In this invention, terms “first”, “second” are merely for illustration, but are not intended to be construed as indicating or implying relative importance. The term “multiple” means two or above, unless otherwise specified explicitly.

A person skilled in the art should appreciate that the examples of the present application may be provided as method, system, or a computer program product. Therefore, the present application may take the form of completely hardware examples, completely software examples, or hardware and software combined examples. Moreover, the present application may take the form of a computer program product implemented on one or more computer readable storage medium (including but not limited to a disk storage, a CD-ROM, an optical disk, etc) containing computer usable program codes.

The present application is described with reference to the flowcharts and/or block diagrams of the method, apparatus (system) and computer program product of the examples of the present invention. It should be understood that a computer program instruction is used to implement each flow and/or block in the flowcharts and/or block diagrams, and combination of flows/blocks in the flowcharts and/or block diagrams. These computer program instructions may be provided to a general-purpose computer, an application specific computer, an embedded processor or processors of other programmable data processing devices to generate a machine such that an apparatus for implementing the functions specified in one or more flow in the flowcharts and/or one or more blocks in the block diagrams is generated through the instructions executed by the computer or the processor of other programmable data processing devices.

These computer program instructions may also be stored in a computer readable memory that can direct the computer or other programmable data processing devices to work in a particular manner such that the instruction stored in the computer readable memory generates a product including an instruction apparatus, which implements the functions specified in one or more flows in the flowchart and/or one or more blocks in the block diagram.

These computer program instructions may also be loaded into a computer or other programmable data processing devices such that a series of operation steps are executed on the computer or other programmable data processing devices to generate computer implemented processing, and thus the instruction executed on the computer or other programmable data processing devices provides the steps for implementing the functions specified in one or more flows in the flowchart and/or one or more blocks in the block diagram.

Although the preferred examples of the present application have been described, a person skilled in the art, once obtaining the basic inventive concept, can make additional variations and modifications to these examples. Therefore, the attached claims are intended to be interpreted as including the preferred examples and all variations and modifications falling into the scope of the present application.

What are described above are merely preferred embodiments of the present invention, but do not limit the protection scope of the present invention. Various modifications or variations can be made to this invention by persons skilled in the art. Any modifications, substitutions, and improvements within the scope and spirit of this invention should be encompassed in the protection scope of this invention.

What is claimed is:

1. A system for authorization and authentication, the system comprising: a server and at least one level of transit terminal, wherein the server comprises:
a data transmission unit, configured to transmit a digital content to the transit terminal, and to transmit an identifier of the server and a business pattern of the digital content to the transit terminal;
a match determination unit, configured to determine whether the server's identifier from the transit terminal, and identifiers of respective transit terminals through which the digital content passes from the server to a lower level transit terminal relative to the transit terminal match predetermined identifiers;
an instruction sending unit, configured to, in the case of matched as determined by the match determination unit, send a confirmation instruction to the transit terminal to enable the transit terminal to transmit the digital content to a client, and in the case of mismatched as determined by the match determination unit, send a rejection instruction to the transit terminal to prevent the transit terminal from transmitting the digital content to a client;
the transit terminal comprises:
a data transit unit, configured to transmit the digital content to the lower level transit terminal, to transmit the server's identifier, the business pattern, and the identifiers of respective transit terminals through which the digital content passes from the server to the lower level transit terminal to the lower level transit terminal, to transmit the server's identifier, the identifiers of respective transit terminals through which the digital content passes from the server to the lower level transit terminal to the server, and to transmit the digital content to the client when receiving the confirmation instruction from the server;
a business pattern parsing unit, configured to, when receiving the confirmation instruction from the server, parse the business pattern;
an authorization unit, configured to authorize the client to make use of the digital content according to a granted privilege obtained through parsing the business pattern.

2. The system of claim 1 wherein the server further comprises:
an identifier determination unit, configured to, in the case of mismatched as determined by the match determination unit, determine identifiers that do not match the predetermined identifiers among the identifier of the server and the identifiers of respective transit terminals through which the digital content passes from the server to the lower level transit terminal, and obtain related information about the mismatched identifiers for displaying.

3. The system of claim 1 wherein the data transit unit is further configured to, when the digital content is transmitted to the client, transmit to the client the identifier of the server and identifiers of respective transit terminals through which the digital content passes from the server to the client; and the server further comprises:
an encryption unit, configured to encrypt the digital content according to a predetermined algorithm;
an identifier obtaining unit, configured to, after receiving a decryption request from the client, obtain from the client the identifier of the server and the identifiers of respective transit terminals through which the digital content passes from the server to the client,
wherein, the match determination unit is further configured to determine whether the identifier of the server and the identifiers of respective transit terminals through which the digital content passes from the server to the client match the predetermined identifiers; the data transmission unit is further configured to, if matched as determined by the match determination unit, send to the client a key corresponding to the predetermined algorithm to enable the client to decrypt the digital content with the key.

4. The system of claim 1 further comprising:
a record obtaining unit, configured to obtain from the transit terminal a record of the transaction between the transit terminal and the client;
wherein the match determination unit is further configured to determine whether a privilege recorded in the transaction record matches a privilege specified in a business pattern corresponding to the transit terminal, and if mismatched, send a prompt message.

5. The system of claim 1 wherein the transit terminal further comprises:
a sharing unit, configured to, after the client obtaining the digital content from the transit terminal has paid for the digital content, share the payment of the client with the server according to a sharing rule obtained through parsing the business pattern.

6. The system of claim 1 wherein the data transit unit is further configured to transmit the business pattern to the server, and the match determination unit is further configured to determine whether the business pattern matches a predetermined business pattern.

7. A server comprising:
a data transmission unit, configured to transmit a digital content to a transit terminal, and to transmit an identifier of the server and a business pattern of the digital content to the transit terminal;
a match determination unit, configured to determine whether the server's identifier from the transit terminal, and identifiers of respective transit terminals through which the digital content passes from the server to a lower level transit terminal relative to the transit terminal match predetermined identifiers;
an instruction sending unit, configured to, in the case of matched as determined by the match determination unit, send a confirmation instruction to the transit terminal to enable the transit terminal to transmit the digital content to a client, and in the case of mismatched as determined by the match determination unit, send a rejection instruction to the transit terminal to prevent the transit terminal from transmitting the digital content to the client.

8. The server of claim 7 further comprising:
an identifier determination unit, configured to, in the case of mismatched as determined by the match determination unit, determine identifiers that do not match the predetermined identifiers among the identifier of the server and the identifiers of respective transit terminals through which the digital content passes from the server to the lower level transit terminal, and obtain related information about the mismatched identifiers for displaying.

9. The server of claim 7 further comprising:
an encryption unit, configured to encrypt the digital content according to a predetermined algorithm;
an identifier obtaining unit, configured to, after receiving a decryption request from the client, obtain from the client the identifier of the server and the identifiers of respective transit terminals through which the digital content passes from the server to the client,
wherein, the match determination unit is further configured to determine whether the identifier of the server and the identifiers of respective transit terminals through which the digital content passes from the server to the client match the predetermined identifiers; the data transmission unit is further configured to, if matched as determined by the match determination unit, send to the client a key corresponding to the predetermined algorithm to enable the client to decrypt the digital content with the key.

10. The server of claim 7 further comprising:
a record obtaining unit, configured to obtain from the transit terminal a record of the transaction between the transit terminal and the client;
wherein the match determination unit is further configured to determine whether a privilege recorded in the transaction record matches a privilege specified in a business pattern corresponding to the transit terminal, and if mismatched, send a prompt message.

11. A transit terminal comprising:
a data transit unit, configured to transmit a digital content from a server to a lower level transit terminal, to transmit to the lower level transit terminal the server's identifier, a business pattern, and identifiers of respective transit terminals through which the digital content passes from the server to the lower level transit terminal, which come from the server, to transmit to the server the server's identifier, and the identifiers of respective transit terminals through which the digital content passes from the server to the lower level transit terminal, and to transmit the digital content to a client when receiving the confirmation instruction from the server;
a business pattern parsing unit, configured to, when receiving the confirmation instruction from the server, parse the business pattern;
an authorization unit, configured to authorize the client to make use of the digital content according to a granted privilege obtained through parsing the business pattern.

12. The transit terminal of claim 11 further comprising:
a sharing unit, configured to, after the client obtaining the digital content from the transit terminal has paid for the digital content, share the payment of the client with the server according to a sharing rule obtained through parsing the business pattern.

13. A method for authorization and authentication comprising:
step 402 of, when a server transmits a digital content to at least one level of transit terminal, transmitting an identifier of the server and a business pattern of the digital content to the transit terminal;
step 404 of, by each of the at least one level of transit terminal, transmitting the digital content to a lower level transit terminal, and transmitting to the lower level transit terminal the identifier of the server, the business pattern, and identifiers of respective transit terminals through which the digital content passes from the server to the lower level transit terminal;
step 406 of transmitting to the server by the transit terminal the identifier of the server and the identifiers of respective transit terminals through which the digital content passes from the server to the lower level transit terminal, and determining by the server whether the identifier of the server and the identifiers of respective transit terminals through which the digital content passes from the server to the lower level transit terminal match predetermined identifiers;
step 408 of, if matched, sending a confirmation instruction to the transit terminal to enable the transit terminal to transmit the digital content to a client, parse the business pattern, and authorize the client to make use of the digital content according to a granted privilege obtained through parsing the business pattern; if mismatched, sending a rejection instruction to the transit terminal to prevent the transit terminal from transmitting the digital content to the client.

14. The method of claim 13 wherein the step 408 further comprises: in the case of mismatched as determined by the server, determining identifiers that do not match the predetermined identifiers among the identifier of the server and the identifiers of respective transit terminals through which the digital content passes from the server to the lower level transit terminal, and obtaining related information about the mismatched identifiers for displaying.

15. The method of claim 13 wherein before the step 402, the method further comprises: encrypting the digital content according to a predetermined algorithm by the server; and the step 408 further comprises: when the transit terminal transmits the digital content to the client, transmitting by the transit terminal to the client the identifier of the server and the identifiers of respective transit terminals through which the digital content passes from the server to the client; wherein after receiving a decryption request from the client, the server obtains from the client the identifier of the server and the identifiers of respective transit terminals through which the digital content passes from the server to the client, determines whether the identifier of the server and the identifiers of respective transit terminals through which the digital content passes from the server to the client match the predetermined identifiers, and if matched, sends a key corresponding to the predetermined algorithm to the client to enable the client to decrypt the digital content with the key.

16. The method of claim 13 further comprising: obtaining by the server from the transit terminal a record of the transaction between the transit terminal and the client, wherein the match determination unit further determines whether a privilege recorded in the transaction record matches a privilege specified in a business pattern corresponding to the transit terminal, and if mismatched, sends a prompt message.

17. The method of claim 13 further comprising: after the client obtaining the digital content from the transit terminal has paid for the digital content, by the transit terminal, sharing the payment of the client with the server, according to a sharing rule obtained through parsing the business pattern.

18. The method of claim 13 wherein the step 406 further comprises: transmitting the business pattern from the transit terminal to the server, and determining whether the business pattern matches a predetermined business pattern by the server.

19. A method for authorization and authentication, the method comprising:
step 502 of transmitting by a server a digital content to at least one level of transit terminal, and transmitting an identifier of the server and a business pattern of the digital content to the transit terminal;
step 504 of determining by the server whether the identifier of the server and identifiers of respective transit terminals through which the digital content passes from the server to a lower level transit terminal relative to the transit terminal, which come from the transit terminal, match predetermined identifiers;
step 506 of, if matched, sending a confirmation instruction to the transit terminal to enable the transit terminal to transmit the digital content to a client; if mismatched, sending a rejection instruction to the transit terminal to prevent the transit terminal from transmitting the digital content to the client.

20. The method of claim 19 further comprising: in the case of mismatched as determined by the server, determining identifiers that do not match the predetermined identifiers among the identifier of the server and the identifiers of respective transit terminals through which the digital content passes from the server to the lower level transit terminal, and obtaining related information about the mismatched identifiers for displaying.

21. The method of claim 19 wherein before the step 502, the method further comprises: encrypting the digital content according to a predetermined algorithm by the server; and the step 506 further comprises: by the server, obtaining from the client the identifier of the server and the identifiers of respective transit terminals through which the digital content passes from the server to the client, after a decryption request from the client is received, and determining whether the identifier of the server and the identifiers of respective transit terminals through which the digital content passes from the server to the client match the predetermined identifiers, and if matched, sending a key corresponding to the predetermined algorithm to the client to enable the client to decrypt the digital content with the key.

22. The method of claim 19 further comprising: obtaining by the server from the transit terminal a record of the transaction between the transit terminal and the client, wherein the match determination unit further determines whether a privilege recorded in the transaction record matches a privilege specified in a business pattern corresponding to the transit terminal, and if mismatched, sends a prompt message.

23. A method for authorization and authentication, the method comprising:
step 602 of, by a transit terminal, transmitting a digital content from a server to a lower level transit terminal, transmitting to the lower level transit terminal the server's identifier, a business pattern, and identifiers of respective transit terminals through which the digital content passes from the server to the lower level transit terminal, which come from the server, transmitting to the server the server's identifier, and the identifiers of respective transit terminals through which the digital content passes from the server to the lower level transit terminal, and transmitting the digital content to a client when receiving a confirmation instruction from the server;
step 604 of, by the transit terminal, when receiving the confirmation instruction from the server, parsing the business pattern, and authorizing the client to make use of the digital content according to a granted privilege obtained through parsing the business pattern.

24. The method of claim 23 further comprising: after the client obtaining the digital content from the transit terminal has paid for the digital content, by the transit terminal, sharing the payment of the client with the server, according to a sharing rule obtained through parsing the business pattern.
